(19) United States
(12) Patent Application Publication
(10) Pub. No.: US 2002/0066523 A1
(43) Pub. Date: Jun. 6, 2002

(54) Attaching devices using polymers

(76) Inventors: Lance L. Sundstrom, Pinellas, FL (US); Kenneth H. Heffner, Pinellas, FL (US)

Correspondence Address: Robert E. Greenstien, Honeywell International Inc., 13350 U.S. Highway 19 North, Clearwater, FL, 33764-7290, US

(21) Appl. No.: 09/730,372

(22) Filed: Dec. 5, 2000

(51) Int. Cl. B29C 31/00

(52) U.S. Cl. 156/229; 156/292

(57) ABSTRACT

A surface treatment or mask that inhibits polymer whetting and bonding is applied to all but the mating bond areas of the interface between a substrate and a device. A polymer material is applied to the bond areas of either the substrate or the device. The device is placed onto the substrate such that the polymer material bridges the mating bond areas of both the substrate and the device. As the polymer material is cured, surface tension pulls it into a vertical column defined by the polymer mask defined mating bond areas of the substrate and device and aligns the mating bond areas directly over each other. Once cured, the polymer forms a mechanical bond and, depending upon the polymer material, forms an electrical, thermal and/or optical connection between the substrate and the device.

### BACKGROUND

This invention relates to techniques for using polymers in electrical/electronic, mechanical and/or optical assemblies.

Solder has been the preferred attachment material in circuit construction because of its high electrical and thermal conductivity and because it “whets” only to certain materials, such as copper, tin, nickel, silver and gold. That selective whetting defines the bond areas, minimizes electrical short circuits between adjacent bond areas and exerts self-aligning forces on surface mounted components during the solder reflow assembly process. The self-alignment force exerted by solder in its liquid state during the solder reflow assembly process is due to the combination of adhesive (whetting) forces between the solder and the exposed metal bond areas that are joined, the cohesive forces within the solder that tend to pull it into a shape with minimum surface area (e.g. a sphere) and the fact that the solder whets only to the exposed metal and not to the solder mask and dielectric materials of the printed wiring board (PWB).

A liquid material may have good whetting to a surface if the adhesive forces to the surface are greater than the cohesive forces within the material. A material with good whetting to a surface (adhesion greater than cohesion) tends to spread out across that surface, whereas a material with poor whetting to a surface (cohesion greater than adhesion) tends to bead up in balls. In their liquid states, polymers and epoxies can provide selective whetting and self-alignment if the whetting can be limited to defined bond areas.

### SUMMARY OF THE INVENTION

An object of the present invention is to provide a more effective and better controlled method of using polymer materials in the construction of electrical/electronic, mechanical and/or optical assemblies.

According to the invention, one or more surface treatments or coating materials are selected to inhibit whetting of polymer materials to areas outside the desired bond areas of a PWB and a device.

According to the invention, a device is attached to a PWB using a process that comprises masking all but the desired bond areas of both mating surfaces with a material such as a parylene that inhibits polymer whetting and bonding, applying one or more polymer attach/interconnect materials to the bond areas of one or both surfaces, placing the device on the PWB and curing the polymer attach/interconnect materials which self-align, bond and connect the device to the PWB.

According the present invention, the mask material may be a chemical vapor deposition (CVD) of an f-ring dimer, a flourinated analog of parylene, with hermetic-like properties. (Chlorinated versions of parylene are called parylene-C or parylene-D.) The applied polymer mask material is then selectively removed from bond areas using a photolithographic process to form polymer mask defined bond areas.

There are many features of the present invention. Polymers cure at much lower temperatures than solders. As a polymer bond cures it transitions through a more liquid state at which time surface tension minimizes its surface area and aligns the mating device and PWB bond areas directly over each other. A polymer is more flexible than solder, and devices attached with a polymer have more shock and g-force resistance. A polymer bond does not loose volume during assembly process and does not have to be cleaned after assembly, unlike a solder bond.

A particular feature, a mix of polymer materials, for example, electrical/thermal/optical/mechanical can be used within the same device interface to satisfy electrical, thermal, optical and mechanical bond and connection requirements. For example, on a single interfacial device interface, electrically conductive, thermally conductive and electrically insulating, electrically insulating and optically conductive materials could be applied to different bond areas of one or both surfaces in complimentary patterns, thus providing any combination of electrical, thermal, mechanical and optical bonds/connections.

Use of the invention can lead to a reduction in packaging size. A typical die (integrated circuit) attachment pad is at least 20 mils larger that the die on each side to allow for die placement accuracy and conductive epoxy bleedout. Wire bond pads are spaced at least another 10 mils beyond that. If a polymer mask or resist ring occupied the space between the die attachment pad and the wire bond pads, the die attach pad could be the same size as the die. The whetting characteristics of the conductive epoxy could be increased to reduce or eliminate voiding at the die bond interface without danger of bleedout (spreading) to the wire bond pads. The die would be self-aligned to the die attach pad by the surface tension of the liquid epoxy as it cures, as explained above. The wire bond pads could be located closer to the die, resulting in reduced bond wire lengths, die footprint size, package size, weight and cost, improved performance and higher device densities at first and second level packaging.

Other objects, benefits and features of the invention will be apparent to one of ordinary skill in the art from the drawing and following description.

### BRIEF DESCRIPTION OF THE DRAWINGS

FIGS. 1-3 are simplified, sequential plan views showing the steps, from left to right, of one method for applying a polymer material and forming an interfacial polymer bond between the mating polymer mask defined bond areas of two surfaces.

FIGS. 4-7 are simplified, sequential, plan views showing the steps, from left to right, of another method for applying a polymer material and forming an interfacial polymer bond between the mating polymer mask defined bond areas of two surfaces.

### DESCRIPTION

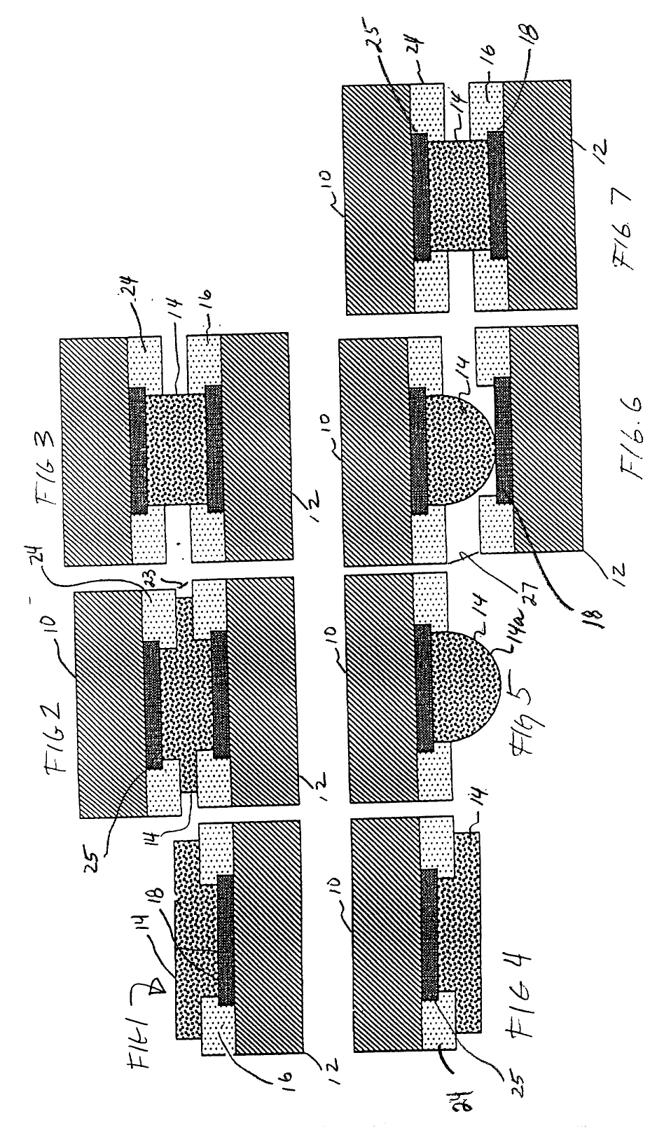

FIGS. 1-3 depict a three step polymer assembly of a device 10 (e.g. a die or a package) with a polymer mask 24 to a substrate 12 (e.g. a package cavity or a PWB) with a polymer mask 16 employing the invention.

FIG. 1 depicts the first step, in which a polymer paste material, (e.g. a thermal cure epoxy or a thermal plastic) 14 is deposited (e.g. screen printed, stenciled or dispensed) onto a substrate bond area 18. The polymer paste material 14 may extend slightly beyond the perimeter of the substrate bond area 18 and onto the substrate polymer mask 16 to insure that enough material volume is applied to form a cured polymer bond 14b of the desired height.

The substrate bond area 18 is defined by an aperture in its polymer mask 16, which may expose a surface conductor, dielectric or an optical via. Likewise, the mating device bond area 25 is defined by an aperture in its polymer mask 24, which may expose a surface conductor, dielectric, an optical via or an active optical device on a die.

FIG. 2 depicts the second step, in which the polymer masked device 10 is placed onto the polymer masked substrate 12 (the host substrate). As shown by arrow 23, some amount of misalignment between the device bond area 25 and the substrate bond area 18 is tolerated.

FIG. 3 depicts the third step, in which the polymer paste material 14 is cured to align, mechanically bond and electrically, thermally and/or optically connect the device bond area 25 to the host substrate bond area 18 with a polymer bond 14b. During this cure process, the polymer paste material 14 initially becomes more liquid and surface tension pulls the polymer paste material 14 into a vertical column, which aligns the device bond area 25 directly over the substrate bond area 18.

FIGS. 4-7 use the same numbers for the same components and shows a four step polymer assembly of a device 10 (e.g. a die or a package) with a polymer mask 24 to a substrate 12 (e.g. a package cavity or a PWB) with a polymer mask 16.

FIG. 4 depicts the first step, in which a polymer paste material 14 (e.g. a thermal cure epoxy or a thermal plastic) is deposited (e.g. screen printed, stenciled or dispensed) onto the device bond area 25. The polymer paste material 14, as before, may extend slightly beyond the perimeter of the device bond area 25 and onto its polymer mask 24 to insure that enough material volume is applied to form a cured polymer bond 14b of the desired height.

The device bond area 25 is defined by an aperture in its polymer mask 24, which may expose a surface conductor or dielectric, an optical via or an active optical device on a die. Likewise, the mating substrate bond area 18 is defined by an aperture in its polymer mask 16, which may expose a surface conductor or dielectric or an optical via.

FIG. 5 depicts the second step, in which the deposited polymer paste material 14 is partially cured to form a polymer bump 14a. During the partial cure process, the polymer paste material 14 initially becomes more liquid and surface tension pulls the material into a hemispherical shape whose base is defined by device bond area 25.

FIG. 6 depicts the third step, in which a polymer masked and “polymer bumped” device 10 is placed onto a polymer masked substrate 12 (the host substrate). As shown by arrow 27, some amount of misalignment between the device bond area 25 and the substrate bond area 18 is tolerated.

FIG. 7 depicts the fourth step, in which the polymer paste material 14 is fully cured to align, mechanically bond and electrically, thermally and/or optically connect the device bond area 25 to the host substrate bond area 18. During that full cure process, the partially cured polymer bump 14a initially becomes more liquid and surface tension pulls the material into a vertical column, aligning the device bond area 25 directly over the substrate bond area 18.

The mask material may be a chemical vapor deposition (CVD) of an f-ring dimer, a flourinated analog of parylene, with hermetic-like properties. The applied polymer mask material is then selectively removed from bond areas using a photo-lithographic process to form polymer mask defined bond areas. A chemical description of examplary repellant polymers include the following: halogenated poly-para-xylylenes formed through a pyrolytic chemical vapor deposition process from such dimers as 4,5,7,8,12,13,15,16-Octafluoro [2.2]paracyclophane. The paracyclophane dimers will work best when halogenated with fluorine moieties although chlorinated dimers could work as well. The advantages of using a chemical vapor deposition process for the barrier material interspersed barrier is the ability to control the height and distribution of the barrier along with the use of a deposition temperature well within the tolerance of microelectronic devices. Furthermore, the deposited halogenated poly-para-cyclophane maskants displays insignificant concentrations of ionic contaminants, and display dielectric properties that make it a preferred insulator. The mechanical properties of the poly-para-cyclophane are highly stable and the material is inert to the environments and process materials presented by the electronics fabricators.

A possible application of the invention is in forming an optical lens on a device or a substrate. An optically clear encapsulating polymer material deposited (e.g. screen printed, stenciled or dispensed onto a circular polymer mask defined bond area can be pulled into a hemispherical shape by the combination of surface tension and selective whetting (adhesion) to the circular bond area. This hemispherical shape acts a very good optical lens. One or more lenses could be deposited on top of a single opto-electronic die. An opto-electronic chip on board (COB) assembly could be completely encapsulated inside a single deposited lens.

Multiple polymer electrical and optical interconnect could be integrated into the flip chip on board (FCOB) footprint of opto-electronic die. FCOB assembly with one or more through hole vias in its host footprint could have independently deposited polymer light pipe paths to lenses and/or another polymer connected FCOB on the backside of the substrate for high speed optical links. Copper and fiber optical interconnect could be integrated into a single PWB by terminating embedded optical fibers in the walls of light pipe vias that connect to polymer connected opto-electronic FCOB assemblies on the surfaces. This could lead to low cost mixed copper and fiber optic backplanes, fiber optic ring laser gyros, etc.

One skilled in the art may make modifications, in whole or in part, to a described embodiment of the invention and its various functions and components without departing from the true scope and spirit of the invention.

1. A method comprising:
depositing a mask material around a bond area on a first component, the masking material having a low whetting characteristic for a polymer attachment material;
applying the polymer attachment material to the bond area;
depositing the mask material around a bond area on a second component;
pressing the bond area on the second component against the polymer attachment material; and
curing the polymer attachment material.

2. The method described in claim 1, wherein the mask material comprises paralyene.

3. The method described in claim 1, where the mask material comprises halogenated poly-para-xylylenes formed through a pyrolytic chemical vapor deposition process from dimers comprising the compound 4,5,7,8,12,13,15,16-Octafluoro[2.2]paracyclophane.

4. The method described in claim 1, wherein the polymer comprises an thermal plastic.

5. The method described in claim 1, wherein the polymer comprises an epoxy.

6. The method described in claim 1, where in the polymer transmits light.

7. The method described in claim 1, wherein the polymer is thermally conductive.

8. The method described in claim 1, wherein the polymer is electrically conductive.

9. A method comprising:
applying a polymer mask around a bond area on a device;
applying a polymer to the attachment pad;
partially curing the polymer to form a polymer bump;
applying the polymer mask around a bond area on a second device, the polymer mask having a low whetting characteristic for the polymer;
pressing the bond area on the second device against the polymer bump; and
fully curing the polymer.

10. The method described in claim 9, wherein the mask comprises halogenated poly-para-xylylenes formed through a pyrolytic chemical vapor deposition process using fluorinated para cyclophane dimers comprised of compounds such as 4,5,7,8,12,13,15,16-Octafluoro [2.2]paracyclophane.

11. A method comprising:
applying a polymer mask around an attachment pad on device;
applying a light transmitting polymer to the attachment;
curing the polymer to form a polymer bump on the attachment pad;
the mask have a low whetting characteristic for the polymer.

12. The method described in claim 11, wherein the polymer transmits light.

13. The method described in claim 11, wherein the polymer is electrically conductive.

14. The method described in claim 11, wherein the polymer is thermally conductive.

15. The method described in claim 11, wherein the polymer is a thermal plastic.

16. The method described in claim 11, wherein the polymer is an epoxy.

17. The method described in claim 11, wherein the mask comprises parylene.

18. The method described in claim 11, wherein the mask comprises halogenated poly-para-xylylenes formed through a pyrolytic chemical vapor deposition process from dimers comprising 4,5,7,8,12,13,15,16-Octafluoro [2.2]paracyclophane.
